(19) United States
(12) Patent Application Publication
(10) Pub. No.: US 2017/0267841 A1
(43) Pub. Date: Sep. 21, 2017

(54) DIPHENYLGUANIDINE-FREE RUBBER MIXTURES CONTAINING POLYETHYLENIMINE

(71) Applicant: LANXESS Deutschland GmbH, Cologne (DE)

(72) Inventors: Ulrich FELDHUES, Bergisch-Gladbach (DE); Heinz UNTERBERG, Dormagen (DE); Joerg HAGEMANN, Cologne (DE); Hermann-Josef WEIDENHAUPT, Pulheim (DE); Melanie WIEDEMEIER-JARAD, Dormagen (DE)

(73) Assignee: LANXESS Deutschland GmbH, Cologne (DE)

(21) Appl. No.: 15/506,275

(22) PCT Filed: Aug. 27, 2015
(86) PCT No.: PCT/EP2015/069671

§ 371 Date: Feb. 24, 2017

(30) Foreign Application Priority Data
Aug. 29, 2014 (EP) 14182915.0

(51) Int. Cl. C08L 7/00

(52) U.S. Cl. CPC C08L 7/00

(57) ABSTRACT

The invention relates to substantially diphenylguanidine-free rubber mixtures each comprising at least a rubber, a silica-based filler and/or carbon black and polyethylenimine, to the production and use thereof and to the vulcanizates thus obtainable,

The invention relates to substantially diphenylguanidine-free rubber mixtures each comprising at least a rubber, a silica-based filler and/or carbon black and polyethylenimine, to the production and use thereof and also to the vulcanizates thus obtainable by the vulcanization process, in particular in the form of tyres, parts of tyres or technical rubber articles.

The invention of the vulcanization of natural rubber provided a novel material whose unique profile of properties have contributed substantially to the development of modern technology. At the beginning of the 20th century the accelerating effect of basic organic compounds was discovered.

DRP 265221 discloses that piperidine was used to accelerate vulcanization in natural rubber, and also in synthetically produced rubbers. Piperidine is toxic, highly volatile and has an unpleasant odour, and the rubber-processing industry therefore sought and used basic alternatives to piperidine early on.

Other Patent publications describe for example aniline and other nitrogen-containing organic compounds such as hexamethylenetetramine and thiocarbanilide as accelerators.

The crosslinking of rubbers with sulphur accelerator systems generally provides the advantage that, through use of different accelerators and combinations thereof, processing and product properties can be varied over wide ranges, for example adjustment of induction period (scorch time, which should ideally not be too short) and reaction rate which is preferably high, thus leading to a short complete vulcanization time. So-called secondary accelerators can be added to the rubber mixtures in order to regulate induction time and vulcanization time.

Guanidine accelerators are counted among the best-known secondary accelerators. These are slow-acting accelerators that can be used to adapt the incipient (scorch) and/or complete vulcanization time, They also counter the retarding effect of acidic fillers.

The modulus curve which is an indicator of vulcanization progress of rubber mixtures comprising guanidine accelerators is typically characterized by a slow increase and a relative late attainment of the maximum. Used alone, these accelerators usually result in a comparatively unfavourable flow time/heating time ratio and in fairly severe reversion in the rubber vulcanizate. To avoid these disadvantages they are often employed in combination with primary accelerators, for example sulphenamide-based accelerators.

However, the guanidine accelerators, in particular diphenylguanidine, allow not only adjustment of the vulcanization behaviour but simultaneously improve various important material properties of the rubber mixture, in particular the Mooney viscosity, and the material properties of the vulcanizate obtained therefrom, for example breaking elongation, tensile strength and 300 modulus.

The reduction in the Mooney viscosity of the rubber mixture is of particular importance for filled rubber mixtures, in particular those which comprise silica-based fillers and/or carbon black and are used for tyres for example. Such rubber mixtures typically have a high Mooney viscosity which markedly impedes processing,

It is known to the person skilled in the art that guanidine accelerators release volatile organic amine compounds under vulcanization conditions, for example the accelerator used most widely in practice, diphenylguanidine (DPG), eliminates aniline during vulcanization. Wishing to avoid emission of these organic amines, in particular aniline, there is a need for novel secondary accelerators.

A great many patents and patent applications describe various DPG-reduced mixtures:

Thus, US 2010/0048775, U.S. Pat. No. 7,605,201, U.S. Pat. No.6,753,374 and U.S. Pat No.7,714,050 propose completely or partly replacing the DPG in rubber mixtures with a special amine or a thiuram disulphide.

WO 2013/104492 describes a rubber mixture comprising 0.65 phr of DPG and 2 phr of polyols such as TMP for example,

FR 2984898 describes mixtures comprising less than 0.45 phr of DPG and 0.4 phr of aminoether alcohols (for example 2-(2-aminoethoxy)ethanol).

FR 2984897 describes mixtures comprising less than 0.5 phr of DPG and less than 0.45 phr of ether amines such as 3-(2-ethylhexyloxy)propylamines.

FR 2984895 describes mixtures comprising less than 0.5 phr of DPG and about 3.0 phr of alkali metal hydroxides and/or alkaline earth metal hydroxides.

FR 2984896 describes mixtures comprising less than 0.5 phr of DPG and less than 8 phr of a primary amine such as hexadecylamine.

However, the above prior art only elaborates on the unchanged or extended scorch time in comparison to the use of DPG and gives the person skilled in the art no indication whatsoever of how the higher Mooney viscosity of the rubber mixtures to be expected as a result of reducing the DPG proportion and the impaired material properties of the vulcanizate obtained therefrom, for example breaking elongation, tensile strength and 300 modulus, may be compensated.

The present invention has for its object to provide rubber mixtures which are of lesser toxicological concern and release no volatile organic amines during vulcanization where the application-relevant properties, i.e. the Mooney viscosity of the rubber mixtures and also the breaking elongation, tensile strength, 300 modulus and complete vulcanization time (T95), of the vulcanizates obtainable therefrom are not substantially worse and ideally better than for the corresponding diphenylguanidine-containing mixtures and vulcanizates.

It has now been found that, surprisingly, use of polyethylenimine together in each case with at least a rubber, a silica-based filler and/or carbon black makes it possible to obtain substantially diphenylguanidine-free rubber mixtures which compared to the DPG-containing equivalents exhibit a lower Mooney viscosity and a shortened complete vulcanization time (T095), the vulcanizate obtainable therefrom exhibiting equal or improved 300 modulus, tensile strength and breaking elongation values compared to DPG-containing vulcanizates.

In the context of the present invention the term substantially diphenylguanidine-free rubber mixtures is to be understood as meaning rubber mixtures comprising not more than 0.4 phr, preferably not more than 0.2, more preferably less than 0.1 and very particularly preferably less than 0.01 phr, of diphenylguanidine. In a preferred embodiment the rubber mixtures have a total content of diphenylguanidine and substituted diphenyiguanidine of not more than 0.4 phr, preferably not more than 0.2 phr, more preferably less than 0.1 phr and very particularly preferably less than 0.01 phr, of diphenylguanidine. In a more preferred embodiment the rubber mixtures have a total content of diphenylguanidine, substituted diphenylguanidine and other organic guanidine derivatives, i.e. compounds where the guanidine function is substituted with one or more C₁-C₈-alkyl groups, C₂-C₈-alkenyl groups C₆-C₈-aryl groups, C₇-C₁₀-aralkyl groups and/or C₁-C₈-heteroalkyl groups, of not more than 0.4 phr, preferably not more than 0.2 phr, more preferably less than 0.1 phr and very particularly preferably less than 0.01 phr, of diphenylguanidine. The unit phr refers to parts by weight based on 100 parts by weight of rubber used in the rubber mixture.

The present invention therefore relates to substantially diphenylguanidine-free rubber mixtures each comprising at least
a rubber,
a silica-based filler and/or carbon black,
polyethylenimine.

The present invention further provides a process for producing substantially diphenylguanidine-free rubber mixtures comprising in each case mixing at least
a rubber,
a silica-based filler and/or carbon black,
polyethylenimine

at batch temperatures of at least 3° C., preferably of 40 to 200° C., particularly preferably at 80 to 150° C. The process is typically performed with shear rates of 1-1000 sec (exp.−1), preferably 1-100 sec (exp.−1). The addition of polyethylenimine may be effected at any point in time during the mixing, also at higher temperatures in the range from 35° C. to 200° C., preferably at a temperature of about 40° C.

The substantially diphenyiguanidine-free rubber mixtures may then be vulcanized in customary fashion after addition of at least one crosslinker.

In a preferred embodiment the rubber mixture according to the invention comprises neither diphenylguanidine nor other organic guanidine derivatives.

The rubber mixture according to the invention may advantageously be employed for producing both zinc-free and zinc-containing rubber vulcanizates.

In the context of the present invention the term polyethylenimine (PEI) is to be understood as meaning homopolymer(s) of ethyleneimine/copolymers of ethyleneimine and one or more comonomers, wherein in the copolymers the proportion of ethyleneimine-derived repeating units in each case based on the total mass of the polymer is at least 50 wt %, preferably at least 80 wt %, more preferably at least 90 wt %, particularly preferably at least 95 wt % and very particularly preferably at least 98 wt %. The term polyethylenimine also comprehends mixtures of homo- and/or copolymers of ethyleneimine, for example with different molecular weights, degrees of branching, comonomers etc.

Such homo- or copolymers typically have a weight-average molecular weight Mw greater than 200, preferably of 300 to 3,000000, particularly preferably from 400 to 800,000, very particularly preferably from 500 to 100,000, more preferably from 600 to 30,000 and most preferably from 700 to 7000.

Polyethylenimine according to the invention may have a linear or branched structure and mixtures of linear and branched polyethylenimine are also usable.

In a preferred embodiment polyethylenimine having a branched structure having not only primary but also secondary and tertiary amino groups is employed.

Ethylenediamine-ethyleneimine copolymers/polyethylenimine homopolymers employable in the present invention are for example those having CAS numbers 25987-06-8 and 9002-98-6.

Rubber mixtures according to the invention preferably comprise from 0.01 to 10 phr, preferably from 0.03 to 3 phr, particularly preferably from 0.1 to 1 phr, more preferably 0.2 to 0.6 phr and very particularly preferably 0.2 to 0.5 phr, of polyethylenimine.

Rubber mixtures according to the invention and rubber vulcanizates according to the invention may preferably also comprise further known rubber additives, for example 1,3-bis((3-methyl-2,5-dioxopyrrol-1-yl)methyl)benzene (CAS No.: 119462-56-5), hexamethylene 1,6-bis(thiosulphate) in particular in the form of disodium salt dihydrate (CAS No.: 5719-73-3) and 1,6-bis(N,N-dibenzylthiocarbamoyldithio)hexane (CAS No. 15190044-6), The anti-reversion agents mentioned can be used individually or in any desired mixture with one another.

In a further preferred embodiment, the rubber mixture may comprise 0.1 to 15 phr of the anti-reversion agent 1,6-bis(N,N-dibenzylthiocarbamoyldithio)hexane (CAS No. 151900-44-6), preferably 0.1-2 phr, particularly preferably 0.2-1.0 phr.

In a further preferred embodiment the rubber mixture may comprise 0.1 to 40 phr, preferably 1 to 12 phr of a C₁-C₄-alkyl ester of glycerol, in particular triacetin,

In the rubber mixture according to the invention the addition of polyethylenimine is preferably effected together with the sulphur and accelerator at batch temperatures of for example 35-200° C. Polyethylenimine may also be added to the rubber separately before or after the sulphur and accelerator.

In a further embodiment poiyethylenimine may be added in the first mixing stage together with silane and silica at batch temperatures of for example 100-250° C. and/or to the rubber(s).

In a further embodiment in the rubber mixture according to the invention the addition of polyethyienimine and the addition of 1,6-bis(N,N-dibenzylthiocarbamoyldithio)hexane (CAS No.: 151900-44-6) can preferably be effected in the first part of the mixing process at batch temperatures of for example 100-250° C., but it can also be effected later at lower temperatures (40-100° C.), for example together with sulphur and/or accelerator.

Polyethyienimine and/or 1,6-bis(N,N6dibenzylthiocarbamayldithio)hexane (CAS No.: 15190-44-6) may be employed independently of one another either in pure form or else ab- and/or adsorbed on an inert, organic or inorganic carrier, preferably a carrier selected from the group comprising natural and synthetic silicates, in particular neutral, acidic or basic silica, aluminium oxide, carbon black and zinc oxide.

Polyethylenimine may also be added to the mixing process as part of a mixture with 1,6-bis (N,N-dibenzyithiocarbamoyidithio)hexane (CAS No.: 151900-44-6).

Furthermore, polyethylenimine may also be added to the mixing process as part of a mixture with glycerol triacetate (triaretin).

The rubber mixtures according to the invention are particularly suitable for the production of tyre treads, subtreads, carcasses and apex mixtures. Tyres/tyre parts here include by way of example treads of summer, winter and all-season tyres, and also treads of car tyres and of lorry tyres.

A further aspect of the present invention provides vulcanizates obtainable by vulcanization of the rubber mixture according to the invention.

The rubber vulcanizates produced are suitable for the production of a great many rubber products, for example for the production of tyre components in particular for tyre treads, subtreads, carcasses, sidewalls, reinforced sidewalls for runflat tyres, apex mixtures, etc., adhesive mixtures and also for the production of technical rubber articles such as damping elements, roll coverings, coverings of conveyor belts, other belts, spinning cops, seals, golf-ball cores, shoe soles, etc. The rubber products according to the invention can in particular provide advantageous operating characteristics to motor vehicles equipped therewith. These motor vehicles therefore likewise form part of the subject-matter of the present invention.

The rubber mixture and rubber vulcanizate according to the invention comprise one or more rubbers such as natural rubber (NR) and/or synthetic rubbers for example. Preferred synthetic rubbers are for example
BR polybutadiene
ABR butadiene/C1-C4-alkyl acryiate copolymer
CR polychloroprene
IR polyisoprene
SBR styrene/butadiene copolymers having styrene contents 1-60, preferably 20-50, wt %
IIR isobutylene/isoprene copolymers
NBR butadiene/acrylonitrile copolymers having acrylonitrile contents of 5-60, preferably 10-50, wt %
HNBR partially or fully hydrogenated NOR rubber
EPDM ethylene/propylene/diene copolymers

In a preferred embodiment the rubber mixture according to the invention comprises at least one nonpolar rubber selected from the group consisting of NR, SBR, BR, IR, SIBR, IIR, ENR and EPDM, preferably from the group consisting of NR, SBR, BR, IIR and EPDM, particularly preferably from the group consisting of NR, BR and SBR, wherein the total content of these nonpolar rubbers in the rubber mixture is typically at least 50 phr, preferably at least 60 phr and particularly preferably at least 70 phr, The content of polar rubbers having a solubility parameter of more than 17.6 such as NBA, HNBR, SNBR, HXNBR and XNBR in the rubber mixture is typically less than 10 phr, preferably less than 1 phr, particularly preferably less than 0.1 phr and very particularly preferably less than 0.01 phr in each case.

Silica-Based filler

Substances employed as silica-containing fillers in the context of this invention include:
silica, in particular precipitated silica or fumed silica, produced for example by precipitation of solutions of silicates or flame hydrolysis of silicon halides having specific surface areas of 5-1000, preferably 20-400, m²/g (BET surface area) and with primary particle sizes of 10-400 nm. The silicas may optionally also be in the form of mixed oxides with other metal oxides, such as oxides of Al, Mg, Ca, Ba, Zn, Zr, Ti.
synthetic silicates, such as aluminium silicate, alkaline earth metal silicates such as magnesium or calcium silicate, having BET surface areas of 20-400 m²/g and a primary particle size of 10-400 nm,
natural silicates, such as kaolin and other naturally occurring silicas,

and mixtures of these substances.

Carbon Black Filler

In addition or alternatively to the silica-based fillers it is possible to use carbon blacks, carbon blacks particularly suitable therefor being those produced by the lamp-black, furnace-black or gas black process having BET surface areas of 20-200 m²/g, such as SAF, ISAF, IISAF, HAF, FEF, and GPF carbon blacks.

The rubber mixtures preferably comprise 5 to 200 phr, particularly preferably 30 to 150 phr, of silica-based fillers. The total proportion of additional fillers, in particular carbon blacks, preferably carbon blacks produced by the lamp-black, furnace-black or gas-black process, in the rubber mixture is typically 0 to 160 phr, preferably 1 to 100 phr, particular preferably 5 bis 80 phr. Provided the rubber mixture comprises carbon black and silica-based fillers the total amount of these two filler types is preferably 20 to 160 phr, particularly preferably 25 to 140 phr.

In a preferred embodiment the content of carbon-black-based fillers relative to silica-based fillers is relatively low.

Rubber mixtures and rubber vulcanizates according to the invention can further comprise one or more sulphur-containing silanes and/or one or more crosslinkers. Sulphur-based or peroxidic crosslinkers are particularly suitable therefor, particular preference being given to sulphur-based crosslinkers.

So-called reclaim rubber such as is described in CN101628994 for example may generally be employed in the rubber mixture according to the invention in any desired amounts.

Sulphur-containing silanes for the rubber mixture and rubber vulcanizates according to the invention that may be employed include: bis(triethoxysilylpropyl) tetrasulphane and the disulphane and also 3-(triethoxysilyl)-1-propanethiol or silanes such as Si 363 from Evonik, Germany or silane NXT/NXT Z from Momentive (previously GE, USA), wherein the alkoxy radical is methoxy or ethoxy, in usage quantities of 2 to 20 parts by weight, preferably 3-11 parts by weight, in each case calculated as 100% active ingredient and based on 100 parts by weight of rubber. However, it is also possible to use mixtures of these sulphur-containing silanes. Liquid sulphur-containing silanes may be absorbed on a carrier (dry liquid) for better meterability and/or dispersibility. Active ingredient content is preferably between 30 and 70 parts by weight, preferably 40 and 60 parts by weight, per 100 parts by weight of dry liquid.

In a further embodiment the present rubber mixtures may comprise 50 to 100 phr of silica-based filler and 0.2 to 12 phr of organic slianes, preferably sulphur-containing organic silanes, particularly preferably sulphur-containing organic silanes comprising alkoxysilyl groups and very particularly preferably sulphur-containing organic silanes comprising trialkoxysilyl groups.

Preferably employed peroxidic crosslinkers include bis(2,4-dichlorobenzyl) peroxide, dibenzoyl peroxide, bis(4-chlorobenzoyl) peroxide, 1,1-bis(t-butylperoxy)-3,3,5-trimethylcyclohexane, tert-butyl perbenzoate, 2,2-bis(t-butylperoxy)butane,4,4-di-tert-butyl peroxynonyl valerate, dicumyl peroxide, 2,5-dimethyl-2,5-di(tert-butylperoxy)hexane, tert-butyl curnyl peroxide,1,3-bis(tert-butylperoxylsopropyl)benzene, di-tert-butyl peroxide and 2,5-dimethyl-2,5-di(tert-butylperoxy)-3-hexyne.

It may be advantageous to use, in addition to these peroxidic crosslinkers, further additions which can help to increase the crossiinking yield: examples of compounds suitable therefor are triallyl isocyanurate, triallyl cyanurate, trimethylolpropane tri(meth)acrylate, triallyl trimellitate, ethylene glycol di(meth)acrylate, butanediol di(meth)acrylate, trimethylolpropane tri(meth)acrylate, zinc diacrylate, zinc dimethacrylate, 1,2-polybutadiene, and N,N′-m-phenylenedimaleimide.

Sulphur may be used as a crosslinker in elemental soluble or insoluble form or in the form of sulphur donors, Examples of contemplated sulphur donors include dimorpholyl disulphide (DTDM), 2-morphollnodithiobenzothiazole (MBSS), caprolactam disulphide, dipentamethylenethiuram tetrasulphide (DPTT), tetramethylthiuram disulphide (TMTD) and tetrabenzylthiuram disulphide (TBzTB). In a preferred embodiment the rubber mixture comprises 0.1-15 phr of TBzTD, preferably 0.1-2 phr, particularly preferably 0.1-0.5 phr.

In principle, the crosslinking of the rubber mixture according to the invention can be effected with sulphur or sulphur donors alone, or together with vulcanization accelerators, suitable examples of which are dithiocarbamates, thiurams, thiazoles, sulphenamides, xanthogenates, bi- or polycyclic amines, dithiophosphates, caproiactams and thiourea derivatives. Also suitable are zinc diamine diisocyanate, hexamethylenetetramine, 1,3-bis(citraconimidomethyl)benzene, and also cyclic disulphanes. The rubber mixtures according to the invention preferably comprise sulphur-based crosslinkers and vulcanization accelerators.

Particular preference is given to using sulphur, magnesium oxide and/or zinc oxide as crosslinking agents, to which the known vulcanization accelerators, such as mercaptobenzothiazoles, thiazolesuiphenamides, thiurams, thiocarbamates, xanthogenates and thiophosphates, are added.

The crosslinking agents and vulcanization accelerators are preferably employed in the rubber mixture according to the invention in amounts of 0.1 to 10 phr, particularly preferably of 0.1 to 5 phr.

The rubber mixture according to the invention and the rubber vulcanizate according to the invention may comprise further rubber auxiliaries, for example adhesion systems, ageing inhibitors, heat stabilizers, light stabilizers, antioxidants, in particular antiozonants, flame retardants, processing aids, impact-resistance improvers, plasticizers, tackifiers, blowing agents, dyes, pigments, waxes, extenders, organic acids, retarders, metal oxides, and activators, in particular triethanolamine, polyethylene glycol, hexanetriol, and anti-reversion agents.

These rubber auxiliaries are employed in customary amounts which depend inter alia on the intended purpose of the vulcanizates. Customary amounts are 0.1 to 30 phr.

Preferred ageing inhibitors used are alkylated phenols, styrenated phenol, sterically hindered phenols such as 2,6-di-tert-butylphenol, 2,6-di-tert-butyl-p-cresol (BHT), 2,6-di-tert-butyl-4-ethylphenol, sterically hindered phenols containing ester groups, sterically hindered phenols containing thioether, 2,2′-methylenebis-(4-methyl-6-tert-butylphenol) (BPH), and also stericaliy hindered thiobisphenols.

If discoloration of the rubber is not important, it is also possible to use aminic aging inhibitors, e,g mixtures of diaryl-p-phenylenediamines (DTPD), octylated diphenylamine (ODPA), phenyl-α-naphthylamine (PAN), phenyl-β-naphthylamine (PBN), preferably those based on phenylenediamine, e,g. N-isopropyl-N′-phenyl-p-phenylenediamine, N-1,3-dimethylbutyl-N′-phenyl-p-phenylenediamine (6PPD), N-1,4-dimethylpentyl-N′-phenyl-p-phenylenediamine (7PPD), N,N′-bis(1,4-dimethylpentyl)-p-phenylenediamine (77PD).

Further ageing inhibitors are phosphites such as tris(nonylphenyl) phosphite, polymerized 2,2,4-trimethyl-1,2-dihydroquinoline (TMQ), 2-mercaptobenzimidazole (MBI), methyl-2-mercaptobenzimidazole (MMBI), zinc methylmercaptobenzimidazole (ZMMBI), these mostly being used in combination with the above phenolic ageing inhibitors. TMQ, MBI, and MMPI are mainly used for NBR rubbers which are vulcanized using peroxides.

Ozone resistance can be improved via antioxidants such as N-1,3-dimethylbutyl-N′-phenyl-p-phenylenediamine (6PPD), N-1,4-dimethylpentyl-N′-phenyl-p-phenylenediamine (7PPD), N,N′-bis(1, 4-dimethylpentyl)-p-phenylenediamine (77PD), enol ethers, or cyclic acetals.

Processing aids should be active between the rubber particles and should counter frictional forces during mixing, plasticizing and forming. Processing aids which may be present in the rubber mixtures according to the invention include all lubricants customary for the processing of plastics, for example hydrocarbons, such as oils, paraffins and PE waxes, fatty alcohols having 6 to 20 carbon atoms, ketones, carboxylic acids, such as fatty acids and montanic acids, oxidized PE wax, metal salts of carboxylic acids, carboxamides and carboxylic esters, for example with the alcohols ethanol, fatty alcohols, glycerol, ethanediol, pentaerythritol and long-chain carboxylic acids as the acid component.

To reduce flammability and to reduce smoke evolution on combustion the rubber mixture composition according to the invention may also comprise flame retardants. Examples of compounds used for this purpose include antimony trioxide, phosphoric esters, chloroparaffin, aluminium hydroxide, boron compounds, zinc compounds, molybdenum trioxide, ferrocene, calcium carbonate and magnesium carbonate.

Further plastics may also be added to the rubber mixture according to the invention and the rubber vulcanizate according to the invention prior to the crosslinking, these acting for example as polymeric processing aids or impact modifiers. These plastics are preferably selected from the group consisting of homo- and copolymers based on ethylene, propylene, butadiene, styrene, vinyl acetate, vinyl chloride, glycidyl acrylate, glycidyl methacrylate, acrylates and methacrylates having alcohol components of branched or unbranched C1- to C10-alcohols, particular preference being given to polyacrylates having identical or different alcohol radicals from the group of C4- to C8-alcohols, in particular of butanol, hexanol, octanol and 2-ethylhexanol, polymethylmethacrylate, methyl methacrylate-butyl acrylate copolymers, methyl methacrylate-butyl methacrylate copolymers, ethylene-vinyl acetate copolymers, chlorinated polyethylene, ethylene-propylene copolymers, ethylene-propylene-diene copolymers.

Known adhesion systems are based on resorcinol, formaldehyde and silica, the so-called RFS direct adhesion systems. These direct adhesion systems may be used in the rubber mixture according to the invention in any desired amount at any point in time during incorporation into the rubber mixture according to the invention.

Suitable formaldehyde donors include not only hexamethylenetetramine but also methylolamine derivatives. A possible adhesion improvement is achieved by addition of components capable of synthetic resin formation such as phenol and/or amines and aldehydes or aldehyde-eliminating compounds to the known rubber mixtures. Compounds widely used as resin-forming components in rubber adhesion mixtures are resorcinol and hexamethylenetetramine (HEXA) (GB Patent 801 928, FR Patent 1 021 959), optionally in combination with silica filler (German Auslegeschrift Patent 1 078 320).

The rubber vulcanizate according to the invention may be used for the production of foams for example. To this end, chemical or physical blowing agents are added thereto. Substances that can be used as chemical blowing agents are any of those known for this purpose, for example azodicarbonamide, p-toluenesulphonyl hydrazide, 4,4′-oxybis(benzenesulphohydrazide), p-toluenesulphonyl semicarbazide, 5-phenyltetrazole, N,N′-dinitrosopentamethylenetetramine, zinc carbonate, or sodium hydrogencarbonate, or else a mixture comprising these substances. Examples of suitable physical blowing agents include carbon dioxide and halogenated hydrocarbons.

The vulcanization of the rubber mixtures according to the invention is typically effected at temperatures of 100-250° C., preferably 130-180° C., optionally at a pressure of 10-200 bar.

The present invention further provides for the use of polyethylenimine for producing the rubber mixtures, vuicanizates and/or rubber products according to the invention.

Production of the Rubber Vulcanizates According to the Invention

Vulcanizates were produced from the rubber formulations of example 1 and of the reference example which are reported in table 1. To this end, the respective constituents of examples 1 to 3 end of the reference example were mixed in respective mixing processes as described below. Complete vulcanization of the rubber mixtures was then effected at 150° C.

Mixing Steps:
The natural rubber (NR, for example TSR/RSS DEFO 1000) was initially charged into a kneader (GK 1.5) and the additives ZINKWEISS ROTSIEGEL, CORAX® N 339, EDENOR® C 18 98-100, VULKANOX® 4020/LG were added at temperatures below 80° C. preferably at about 40° C. and about 40 revolutions.
This NR rubber mixture was then placed on a temperature-controlled roll and the products CHANCEL 90/95 ground sulphur, VULKACIT® CZ/C, RHENOGRAN DPG-80 and/or the polyethylenimine were added and incorporated into the rubber mixture. The roll temperature is below 100° C., preferably below 50° C., very particularly preferably at approximately 40° C.

The rubber mixtures and vulcanizates produced were subjected to the technical tests set out below. The determined values are reported in table 2.

The mixing steps and the sequence of additives may be varied as desired and polyethylenimine may be added in any desired mixing step.

Determination of Properties of Rubber Mixture/Vulcanizates:

Measurement of Mooney Viscosity:

Determination was effected by means of a shearing disc viscometer in accordance with ASTM D1646. The viscosity may be determined directly from the force with which the rubbers (and rubber mixtures) resist processing. In the Mooney shearing disc viscometer, a fluted disc is surrounded, above and below, by test substance and is rotated at about two revolutions per minute in a heatable chamber. The force required therefor is measured as torque and corresponds to the respective viscosity. The sample is generally preheated to 100° C. for one minute; the measurement takes a further 4 minutes over which time the temperature is kept constant, The viscosity is reported together with the respective test conditions, for example ML (1+4) 100° C. (Mooney viscosity, rotor size L, preheat time and test time in minutes, test temperature).

Rheometer (Vulcameter) Complete Vulcanization Time 150° C. (t95):

The MDR (moving die rheometer) vulcanization profile and analytical data associated therewith are measured in an MDR 2000 Monsanto rheometer in accordance with ASTM D5289-95. The time at which 95% of the rubber has been crosslinked is determined as the complete vulcanization time, The selected temperature was 150° C.

Breaking Elongation, Tensile Strength, 300 Modulus:

These measurements were effected in accordance with DIN 53504 (tensile test, rod S 2).

TABLE 1
Rubber formulation
The present invention shall be elucidated hereinbelow through examples but shall not be
restricted thereto.
Constituents of the rubber preparations according to the invention:

| rubber formulation | comparison | reference | example 1 |
|---|---|---|---|
| TSR/RSS DEFO 1000 | 100 | 100 | 100 |
| Red seal zinc white | 5 | 5 | 5 |
| Edenor C 1898-100 | 3 | 3 | 3 |
| Corax N 330 | 45 | 45 | 45 |
| Tudalen 1849-TE | 5 | 5 | 5 |
| Vulkanox 4020/LG | 2 | 2 | 2 |
| VULKACIT CZ/C | 1.5 | 1.5 | 1.5 |
| Chancel 90/95 ground | 1.5 | 1.5 | 1.5 |
| sulphur | | | |
| RHENOGRAN DPG-80 | — | 0.6 | — |
| Lupasol PR 8515 | — | — | 0.6 |

| trade name | description | produced/marketed by |
|---|---|---|
| TSR/RSS (premasticated | NR | Weber & Scheer GmbH & Co |
| to DEFO hardness 1000) | | |
| CORAX N 339 | carbon black | Degussa-Evonik GmbH |
| RHENOGRAN DPG-80 | diphenylguanidine | RheinChemie |
| TUDALEN 1849-TE | mineral oil | Hansen & Rosenthal KG |
| EDENOR C 18 98-100 | stearic acid | Cognis Deutschland GmbH |
| VULKANOX 4020/LG | N-1,3-dimethylbutyl-N-phenyl-p- | Lanxess Deutschland |
| | phenylenediamine | GmbH |
| RED SEAL ZINC WHITE | zinc oxide | Grillo Zinkoxid GmbH |
| VULKACIT CZ/C | N-cyclohexyl-2- | Lanxess Deutschland |
| | benzothiazolesulphenamide | GmbH |
| CHANCEL 90/95 ground | sulphur | Solvay Deutschland GmbH |
| sulphur | | |
| Lupasol PR 8515 | polyethylenimine CAS No.: | BASF AG |
| (polyethylenimine) | 25987-06-8 | |

Quantities reported in phr (parts by weight per 100 parts of rubber)

TABLE 2
Summary of results

| rubber formulation | | comparison | reference | example 1 |
|---|---|---|---|---|
| ML 1 + 4 (Mooney | MU | 21 | 24 | 20 |
| viscosity) | | | | |
| complete vulcanization | s | 546 | 424 | 320 |
| time (t95) | | | | |
| 300 modulus | % | 11.1 | 11 | 10.7 |
| breaking | MPa | 625 | 560 | 613 |
| elongation | | | | |
| tensile strength | MPa | 32.4 | 29.1 | 31.6 |

### EXAMPLES 2 TO 4

Examples 2 to 4 were performed analogously to example 1, the sole difference compared to example 1 being that smaller amounts rather than 0.6 phr of polyethylenimine were employed. While retaining the low Mooney viscosity an advantageous reduction in the complete vulcanization time (t95) compared to the reference example and the comparative example was achieved, coupled with the still excellent vulcanisation properties reported in table 3.

TABLE 3
Summary of results for examples 2 to 4

| rubber formulation | | example 2 | example 3 | example 4 |
|---|---|---|---|---|
| fractions of polyethylenimine | phr | 0.5 | 0.4 | 0.3 |
| complete vulcanization | s | 337 | 353 | 379 |
| time (t95) | | | | |
| 300 modulus | % | 11.2 | 11.4 | 10.7 |
| breaking elongation | MPa | 610 | 591 | 628 |
| tensile strength | MPa | 31.9 | 30.5 | 31.6 |

It was found that, surprisingly, the use of polyethylenimine instead of diphenylguanidine or organic guanidine compounds makes it possible to obtain rubber mixtures having application properties that are not only at the same level as those of the guanidine-containing equivalents but are in fact superior particularly in respect of Mooney viscosity and complete vulcanization time (t195) and of 300 modulus, tensile strength and breaking elongation of the vulcanizates obtainable therefrom.

The rubber mixtures according to the invention exhibited no dispersion problems. Little or no aniline is liberated during processing.

1. A rubber mixture comprising;
a rubber
a silica-based filler and/or carbon black, and
polyethylenimine,
wherein, if present, the rubber mixture has a total content of diphenylguanidine and/or substituted diphenylguanidine that is not more than 0.4 phr.

2. The rubber mixture according to claim 1, wherein the rubber mixture has a content of the polyethylenimine of 0.01 to 10 phr.

3. The rubber mixture according to claim 1, wherein, if present, the rubber mixture has a total content of diphenylguanidine and/or other organic guanidine derivatives that is not more than 0.4 phr.

4. The rubber mixture according to claim 1, wherein the polyethylenimine has a proportion of ethyieneimine-monomer-derived repeating units of at least 80 wt based on the total mass of the polymer.

5. The rubber mixture according to claim 1, rubber comprises at least one rubber selected from the group consisting of NR, SBR, BR, IR, IIR, ENR and EPDM, preferably NR, SBR, BR, IIR end EPDM, particularly preferably NR, BR and SBR.

6. The rubber mixture according to claim 1, further comprising at least one crosslinker, preferably at least one peroxidic or sulphur-based crosslinker, particularly preferably at least one crosslinker from the group comprising sulphur, dimorpholyl disulphide (DTDM), 2-morpholinodithiobenzothiazole (MBSS), caprolactam disulphide, dipentamethylenethiuram tetrasulphide (DPTT), tetramethylthiuram disulphide (TMTD) and tetrabenzylthiuram disulphide (TBzTD, CAS No.: 10591-85-2), in particular TBzTD.

7. The rubber mixture according to claim 1, wherein the rubber mixture comprises the at least one silica-based filler, preferably silica having a specific BET surface area of 5 to 1000 m²/g, particularly preferably 20-400 m²/g

8. The rubber mixture according to claim 1, further comprising 50 to 100 phr of hydroxyl-containing oxidic filler and 0.2 to 12 phr of organic silanes, preferably sulphur-containing organic silanes, particularly preferably sulphur-containing organic silanes comprising alkoxysilyl groups and very particularly preferably sulphur-containing organic silanes comprising trialkoxysilyl groups.

9. The rubber mixture according to claim 1, wherein the polyethylenimine is absorbed on a carrier and/or adsorbed on a carrier, preferably a carrier selected from the group consisting of natural and synthetic silicates, in particular neutral, acidic or basic silica, aluminium oxide, carbon black, zinc oxide and mixtures thereof.

10. The rubber mixture according to claim 1, further comprising 0.1 to 15 phr of 1,6-bis(N,N-dibenzylthiocarbamoyldithio)hexane and/or hexamethylene-1,6-bis(thiosulphate) as acid or salt, preferably 0.1 to 2 phr of 1,6-bis(N,N-dibenzylthiocarbamoyldithio)hexane, and most preferably 0.2 to 1 phr of bis(N,N-dibenzylthiocarbamoyldithio)hexane.

11. A process for producing the rubber mixture according to claim 1, the process comprising mixing at least the rubber, the silica-based filler and/or carbon black and the polyethylenimine with one another, preferably at a temperature of at least 30° C., preferably of 40 to 200° C., particularly preferably at 80 to 150° C.

12. A process for producing rubber vulcanizates from the mixture according to claim 1, the process comprising vulcanizing the rubber mixture according to claim 1, preferably at a temperature of 100 to 250° C., particularly preferably of 130 to 180° C.

13. A vulcanizate obtained by vulcanization of the rubber mixtures according to claim 1.

14. Rubber products, preferably technical rubber articles and tyres comprising one or more rubber vulcanizates according to claim 13.

15. A vehicle comprising the rubber product according to claim 14.

16. (canceled)

17. The rubber mixture according to claim 1, wherein:
a total content of diphenylguanidine and/or substituted diphenylguanidine is not more than 0.2 phr,
a total content of diphenyiguanidine and other organic guanidine derivatives is not more than 0.2 phr;
the content of polyethylenimine is 0.03 to 3 phr; and
the polyethylenimine has a proportion of ethyleneimine-monomer-derived repeating units of at least 90 wt % based on the total mass of the polymer.

18. The rubber mixture according to claim 1, wherein:
a total content of diphenylguanidine and/or substituted diphenylguanidine is<0.01 phr;
a total content of diphenylguanidine and other organic guanidine derivatives is<0.01 phr;
the content of polyethylenimine is 0.2 to 0.5 phr; and
the polyethylenimine has a proportion of ethyleneimine-monomer-derived repeating units of at least 98 wt % based on the total mass of the polymer.

19. The rubber mixture according to claim 17, wherein:
the rubber comprises at least one rubber selected from the group consisting of NR, SBR, BR, IIR and EPDM;
the rubber mixture comprises the at least one silica-based filler, and the silica-based filler comprises silica having a specific BET surface area of 5 to 1000 m²/g;
the polyethylenimine is absorbed on a carrier and/or adsorbed on a carrier, wherein the carrier is selected from the group consisting of natural and synthetic silicates; and
the rubber rraixture further comprises:
at least one crosslinker selected from the group consisting of sulphur, dimorpholyl disulphide (DTDM), 2-rnorpholinodithiobenzothiazole (MBSS), caprolactam disulphide, dipentamethylenethiuram tetrasulphide (DPTT), tetramethylthiuram disulphide (TMTD) and tetrabenzylthiurarn disulphide (TBzTD);
50 to 100 phr of hydroxyl-containing oxidic filler and 0.2 to 12 phr of sulphur-containing organic silanes; and
0.1 to 15 phr of 1,6-bis(N,N-dibenzylthiocarbamoyldithio)hexane and/or hexamethylene-1,6-bis(thiosulphate) as acid or salt, preferably 0.1 to 2 phr of 1,6-bis(N,N-dibenzylthiocarbamoyldithio)hexane, and most preferably 0.2 to 1 phr of bis(N,N-dibenzylthiocarbamoyldithio)hexane.

20. The rubber mixture according to claim 18, wherein:
the rubber comprises at least one rubber selected from the group consisting of NR, BR and SBR;
the rubber mixture comprises the at least one silica-based filler, and the silica-based filler comprises silica having a specific BET surface area of 20-400 m²/g;
the polyethylenimine is absorbed on a carrier and/or adsorbed on a carrier, wherein the carrier is selected from the group consisting of neutral, acidic or basic silica, aluminium oxide, carbon black, zinc oxide and mixtures thereof; and
the rubber mixture further comprises:
TBzTD as crosslinker;
50 to 100 phr of hydroxyl-containing oxidic filler and 0.2 to 12 phr of sulphur-containing organic silanes comprising trialkoxysilyi groups; and
0.2 to 1 phr of bis(N,N-dibenzylthiocarbamoyldithio) hexane.
